(19) United States
(12) Patent Application Publication
(10) Pub. No.: US 2026/0071635 A1
(43) Pub. Date: Mar. 12, 2026

(54) Containment Case for Gas Turbine Engine

(71) Applicants: Rolls-Royce Corporation, Indianapolis, IN (US); Rolls-Royce North American Technologies, Inc., Indianapolis, IN (US)

(72) Inventors: Robert W. HEETER, Indianapolis, IN (US); Philip M. BASTNAGEL, Indianapolis, IN (US); Allen BARTA, Indianapolis, IN (US); Matthew J. KAPPES, Indianapolis, IN (US)

(21) Appl. No.: 18/803,242

(22) Filed: Aug. 13, 2024

(51) Int. Cl. F04D 29/52; F01D 21/04

(52) U.S. Cl. CPC F04D 29/526; F01D 21/045; F05D 2220/36; F05D 2230/90; F05D 2240/14; F05D 2300/502; F05D 2300/506; F05D 2300/518; F05D 2300/603; F05D 2300/605; F05D 2300/611

(57) ABSTRACT

A fan containment case includes a barrel that includes a case structure and a nanocrystalline metal coating overlying the case structure. The case structure includes a plurality of carbon fiber bands, in which at least an outermost carbon fiber band and an innermost carbon fiber band include a fire resistant polymer matrix. The case structure also includes at least one cut resistant polymer band between the outermost and the innermost carbon fiber bands.

### TECHNICAL FIELD

The present disclosure generally relates to fan containment cases for gas turbine engines.

### BACKGROUND

Various gas turbine engines, such as turbofans, include a fan surrounded by a hardwall containment case. During operation, fan blades may break off from the fan and impact the hardwall containment case; this is generally referred to as a fan blade-off (FBO) event. After a turbine engine loses a fan blade, the loads on the containment case rise well above those experienced in normal flight conditions due to imbalance. After an FBO, the aircraft must be able to make up to a multiple hour diversion to an airport so residual structural integrity is vital. The hardwall containment case should minimize the damage caused by the impact of the FBO. If the hardwall containment case fails during the windmill operation before an emergency landing is feasible, the consequences for the engine and aircraft may be catastrophic. Damage tolerant designs are important to maintain integrity while capturing a release blade.

### SUMMARY

The disclosure describes example lightweight, thin, and cut and fire resistant containment cases for gas turbine engines. A containment case includes a lightweight and mechanically robust case structure. The case structure includes one or more cut resistant polymer bands that provide cut resistance to the containment case and two or more carbon fiber bands, including innermost and outermost carbon fiber bands, that provide structural integrity to the containment case. The innermost and outermost carbon fiber bands are embedded in a fire resistant resin and coated with a nanocrystalline metal coating that provides environmental resistance for the containment case's cut resistant fibers and enables the containment case to be constructed from fewer carbon fiber layers than otherwise would have been required for environmental isolation. In this way, the case structure may have a reduced weight and thickness while providing sufficient mechanical strength to resist damage from impact and cutting.

In some examples, the disclosure describes a containment case that includes a barrel that includes a case structure and a nanocrystalline metal coating overlying the case structure. The case structure includes a plurality of carbon fiber bands, including an outermost carbon fiber band and an innermost carbon fiber band embedded in a fire resistant polymer matrix, and at least one cut resistant band between the outermost and the innermost carbon fiber bands. In some examples, the disclosure describes a gas turbine engine that includes the containment case described above.

In some examples, the disclosure describes a method of fabricating a containment case. The method includes forming a nanocrystalline metal coating overlying a case structure. The case structure includes a plurality of carbon fiber bands including an outermost carbon fiber band and an innermost carbon fiber band, and at least one cut resistant band between the outermost and the innermost carbon fiber bands.

The details of one or more examples are set forth in the accompanying drawings and the description below. Other features, objects, and advantages will be apparent from the description and drawings, and from the claims.

### BRIEF DESCRIPTION OF THE DRAWINGS

FIG. 1 is a cross-section side view diagram illustrating an example gas turbine engine that includes a fan containment case.

FIG. 2 is a cross-section side view diagram illustrating an example containment case.

FIG. 3A is a cross-section side view diagram illustrating an example barrel of a containment case.

FIG. 3B is an expanded cross-section side view diagram illustrating the example barrel of FIG. 3A.

FIG. 4 is a cross-section side view diagram illustrating an example barrel of a containment case that includes more than one cut resistant polymer band.

FIG. 5 is a cross-section side view diagram illustrating an example barrel of a containment case that includes an inner cavity for accommodating a fan track liner.

FIG. 6 is a flowchart of an example method for fabricating a barrel of a containment case.

### DETAILED DESCRIPTION

The disclosure describes example lightweight, thin, and cut and fire resistant containment cases for gas turbine engines. A hardwall containment case includes a barrel that does not substantially deflect in a radial direction and a fan track liner that surrounds a rotor having fan blades. The hardwall containment case is designed to contain high energy debris projectiles within the barrel and reduce penetration of broken off fan blades into the barrel. In an FBO event, a broken off and fast moving fan blade may cut through the fan track liner, but may not penetrate through the barrel, instead remaining contained and confined within the interior of the barrel.

A hardwall containment case may be used in applications having a slimline nacelle or embedded integration. To achieve a low weight, a structural component may incorporate a carbon fiber composite for its high strength and stiffness. However, carbon fiber is also relatively brittle (possesses low toughness) so may not be effective to resist cutting and achieve a slim profile compared to designs with a cut resistance fiber. Incorporation of cut resistant layers into the carbon fiber composites may be difficult due to challenges incorporating them. For example, aramid fibers (such as brand name KEVLAR®) are difficult to bond to while others may be susceptible to degradation due to moisture like benzobisoxazole (PBO) (such as brand name ZYLON®). These fibers might lead to delamination or require substantial layers of carbon fiber to provide adequate isolation from moisture. Therefore, to maintain both a slim and lightweight design with high integrity, an environmental barrier may be incorporated for cut resistant fibers. While a few epoxy resins are available with flame resistance and low moisture sensitivity, they may be temperature limited which challenges capability needs. If an epoxy resin is not flame resistant, the case and other fire walls may require further fire protection, which may increase cost and weight. Alternatively, a higher temperature capable and inherently fire-resistance resin such as benzoxazine could be used—which is also tough for impact strength.

According to principles of the disclosure, containment cases described herein may have a reduced weight and thickness, and enables less material and labor or processing time to lay-up, roll-wrap, or over-braid compared to thicker designs. The containment case includes a barrel having a case structure that contains fan blades and a nanocrystalline metal coating that provides environmental protection to the case structure. The environmental protection provided by the nanocrystalline metal coating may enable fabrication of the case structure using fewer layers of supportive and protective material, such as carbon fiber layers. The nanocrystalline metal coating may be a thin layer deposited onto carbon fiber layers at the surface of the case structure using electrodeposition. In addition to providing environmental protection, the hard nanocrystalline metal coating may enable interfacing of the containment case with other structures without the use of additional flanges, wear strips, or other metallic structures and further aid in impact robustness. The resulting barrel may have fewer layers, greater temperature capability, and inherent fire resistance.

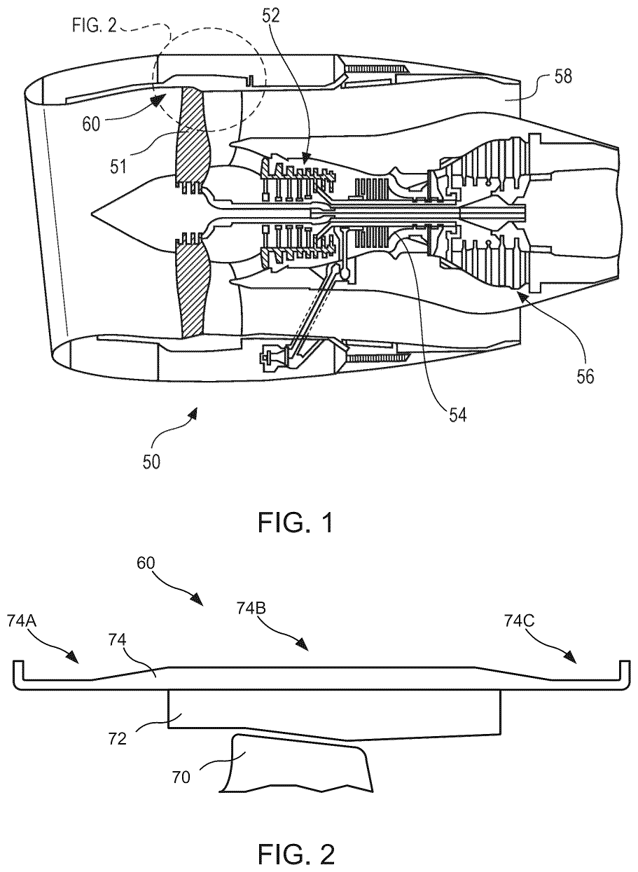

FIG. 1 is a cross-section side view diagram illustrating an example gas turbine engine 50 that includes a hardwall fan containment case 60. Gas turbine engine 50 may be used to power aircraft, such as helicopters, airplanes, and unmanned space vehicles. However, a containment case as described herein may be used for applications other than aircraft, such as industrial applications, power generation, booster stage containment (e.g., low pressure compressor aft of a fan), pumping sets, naval propulsion, weapon systems, security systems, perimeter defense/security systems, and the like.

In the example of FIG. 1, gas turbine engine 50 is illustrated as having a fan 51, a compressor section 52, a combustor 54, and a turbine section 56, which together can be used to generate power. In operation, air enters gas turbine engine 50, is compressed by compressor section 52, is mixed with fuel, and is combusted in combustor 54. Turbine section 56 is arranged to receive the combusted mixture of air and fuel from combustor 54 and extract useful work from the mixture. Fan 51 includes a rotor having a plurality of fan blades.

Fan containment case 60 is configured to contain high energy debris projectiles and reduce penetration of broken off fan blades of fan 51 into fan containment case 60. FIG. 2 is a cross-section side view diagram illustrating an example fan containment case 60. Fan containment case 60 includes a barrel 74 and a fan track liner 72. Barrel 74 has a forward portion 74A, an aft portion 74C, and a middle portion 74B in between forward portion 74A and aft portion 74C. Fan containment case 60 is located outboard of rotor fan blades 70. Fan track liner 72 is positioned between barrel 74 and fan blades 70 and is immediately outboard of the fan blades 70. Fan track liner 72 may be configured to abrade in response to contact with fan blades 70, and may be constructed from a variety of materials including, but not limited to, metallic, plastic, composite, honeycomb, or the like. Fan track liner 72 can be constructed as a single article or as an article that has portions fastened or bonded to one another in the form of a layered composition.

To prevent a potential failure of gas turbine engines, barrel 74 is configured for stability and structural and environmental integrity. Rather than use bulk metals as primary load supporting structures, which may be relatively heavy, barrel 74 may include a carbon fiber composite as a structural material. Incorporation of carbon fiber composites as a bulk material of barrel 74 may reduce an overall of weight of fan containment case 60 and maintains the structural integrity and strength of the barrel 74.

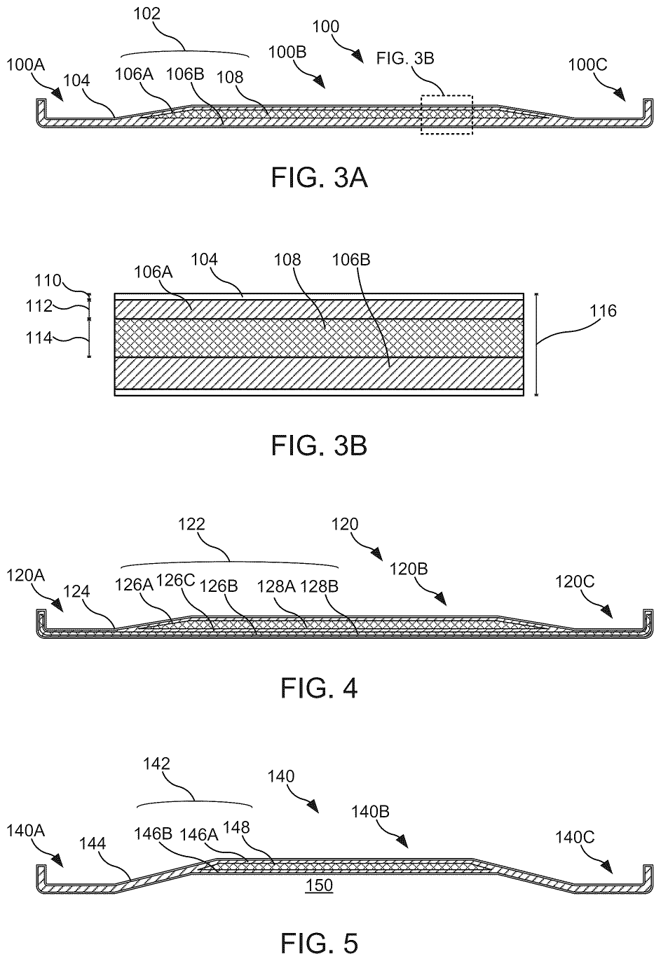

In addition to being lightweight, fan containment cases described herein may also resist cutting and maintain thermal stability. FIG. 3A is a cross-section side view diagram illustrating an example barrel 100 of a containment case, such as barrel 74 of fan containment case 60 of FIGS. 1 and 2. Barrel 100 includes a case structure 102. Case structure 102 includes a plurality of carbon fiber bands 106 including an outermost carbon fiber band 106A forming an outer surface of case structure 102 and an innermost carbon fiber band 106B forming an inner surface of case structure 102. Each carbon fiber band 106 may be formed from layers of carbon fiber combined with a polymer matrix. Carbon fiber bands 106 may be configured to catch and hold a penetrating projectile, such as a portion of fan blade 70 in the event of an FBO.

While carbon fiber bands 106 may provide enhanced mechanical strength to case structure 102, a carbon fiber composite may be susceptible to cutting. For example, barrel 100 includes a forward portion 100A, a middle portion 100B, and an aft portion 100C. A fan blade or other high energy debris may impact the carbon fiber composite near middle portion 100B and cut through the composite. To resist this cutting, case structure 102 includes at least one cut resistant polymer layer 108 (“polymer layer 108”) between outermost carbon fiber band 106A and innermost carbon fiber band 106B. In the example of FIG. 3A, middle portion 100B includes polymer band 108; however, in other examples, polymer band 108 may be present in other portions of barrel 100, such as forward portion 100A and/or aft portion 100C.

Polymer band 108 is cut resistant to debris encountered during operation of the gas turbine engine. Such debris may include ice formed on fan blades; foreign object debris (FOD) that be ingested by the gas turbine engine, such as stones, loose pavement, tools, or other objects found on the runway or taxiway; fragments of fan blades; or other solid particles that may enter the gas turbine engine during flight or grounded conditions. If fan blade 70 or other fast moving high energy debris hits middle portion 100B, fan blade 70 may cut through innermost carbon fiber band 106B, but may be stopped by polymer band 108. Various properties that render a material cut resistant may include, but are not limited to, high tensile strength, such that polymer band 108 may withstand stretching forces without breaking; toughness, such that polymer band 108 may absorb energy and plastically deform without fracturing; hardness, such that polymer band 108 may better resist penetration and abrasion; crystalline microstructure; chemical composition; surface treatment and coatings; and the like. A variety of polymers may be used for polymer band 108 including, but not limited to, poly p-phenylene-2,6-benzobisoxazole (PBO), aramid fibers (e.g., KEVLAR), ultra-high molecular weight polyethylene (UHMWPE), polyether ether ketone (PEEK), polyimide, and the like. Due to a presence of polymer band 108, a thickness of middle portion 100B may be greater than a thickness of forward portion 100A and aft portion 100C.

In some examples, polymer layer 108 includes poly p-phenylene-2,6-benzobisoxazole (PBO). The PBO may be present as layers of fiber, and/or may be in a composite form combined with a polymer such as epoxy, benzoxazine, PEEK, phenolic or the like. PBO may have a high resistance to cutting, such as a tensile strength greater than about 180 gigapascal (GPa) and an elongation at break greater than about 2.5 percent (%). PBO may have a relatively low density compared to other fibers having high cut resistance, such as about 1.56 grams per cubic centimeter (g/cm³). In some examples, the PBO may be a dry PBO, such as dry PBO fibers. For example, dry PBO patches may be included in polymer layer 108 to improve elongation to failure feature of the PBO without substantial effects on the structural stability of barrel 100. In some examples, The PBO may be a PBO composite infused with a polymer. For example, a polymer, such as epoxy, may contribute to a structural strength and stability of barrel 100.

In addition to maintaining structural integrity and cut resistance, barrel 100 is configured to be fire resistant. For example, while barrel 100 may only experience temperatures up to 65° C. during normal operation, in the event of a fire or other adverse event, barrel 100 may be expected to resist substantially higher temperatures, such as greater than about 140° C. Such resistance may be required by aircraft regulations in order for barrel 100 to meet when flame is applied to the outer diameter of barrel 100.

To provide fire resistant to barrel 100, at least a portion of carbon fiber bands 106, including each of innermost carbon fiber band 106A and outermost carbon fiber band 106B, are configured to be fire resistant at temperatures encountered during operation of the gas turbine engine, including normal and exceptional operation. The polymer matrix of carbon fiber bands 106 includes a fire resistant polymer matrix having fire resistance sufficient to resist flammability and/or resist thermal degradation. Properties for which the polymer matrix may be selected include, but are not limited to: high char yield, such that the polymer matrix forms a stable char layer upon exposure to high temperatures, which may act as a barrier to slow down the release of combustible gases and heat, thereby enhancing fire resistance; low heat release rate during combustion, which may help in reducing the spread of fire; intrinsic flame retardant properties; low smoke production; thermal stability to withstand higher temperatures before degrading; and the like. In some examples, the polymer matrix of carbon fiber band 106 has a total heat release less than about five kilojoules per gram (kJ/g), such that carbon fiber band 106 may be at less risk of combustion in response to a fire; alternatively, it may also have a total heat release of less than 10 kJ/g. Fire resistant polymers that may be used include, but are not limited to, benzoxazine, epoxy resins, phenolic resins, polyimides, polyphthalamide (PPA), polyphenylene oxide (PPO), melamine resins, silicone resins, and the like.

In addition to at least a portion of polymer bands 106 being fire resistant, in some examples, polymer band 108 may also be configured to be fire resistant at temperatures encountered during operation of the gas turbine engine. Fire resistant polymers that may be used include, but are not limited to, benzoxazine (PBO), polyether ether ketone (PEEK), phenolic resins, and the like. For example, polymer band 108 may include a cut resistant fiber in PEEK wrapped around innermost carbon fiber band 106A. A film adhesive may be used to avoid delamination and secure the 108 to 106 if not using a uniform resin matrix. In other examples, carbon fiber bands 106A, 106B, and polymer bands 108 may use a same fire resistant resin, such that delamination may be mitigated.

For carbon fiber bands 106A and 106B and polymer band 108, a band represents one or multiple layers of a material, such that each carbon fiber band 106 include one or more layers of carbon fibers and each polymer band 108 includes one or more layers of polymer fibers. For example, a “band” may refer to an arrangement of one or more layers of a same or similar material radially through a wall of barrel 100.

In addition to impact damage, barrel 100 may be exposed to environmental damage. For example, barrel 100 may encounter oxidizing species, such as water, that may damage susceptible materials, such as polymer layer 108, within barrel 100. To protect case structure 102, particularly polymer layer 108, from environmental damage, barrel 100 includes a nanocrystalline metal coating 104 (“metal coating 104”) overlying case structure 102. Metal coating 104 is configured to resist migration of oxidizing species, such as water, from penetrating into case structure 102.

Metal coating 104 includes a nanocrystalline metal or metal alloy that is mechanically and chemically robust to resist damage, such as cracking or delamination. A nanocrystalline metal or metal alloy may be a metal or metal alloy having a crystalline grain size in the nanometer range, such as less than about 100 nanometers. Due to this small grain size, metal coating 104 may have increased hardness, strength, wear resistance, ductility, corrosion resistance, and/or oxidation resistance compared to a metallic coating having coarser grains. In some examples, metal coating 104 has a relatively high ductility to resist fracture, such as a ductility greater than about 1% elongation. In some examples, metal coating 104 has a relatively high hardness to resist impact, such as a hardness greater than about 400 Vickers (HV).

In some examples, metal coating 104 is configured to provide sufficient hardness such that metal coating 104 may act as a localized structural component. For example, barrel 100 may be coupled to other portions of a gas turbine engine using fasteners. To accommodate a composite such as a carbon fiber composite, which may be subject to abrading, fan containment cases without a metal coating may incorporate flanges at forward portion 100A and aft portion 100C. In contrast, metal coating 104 may be sufficiently hard to accommodate the fasteners, such that additional flanges may not be required, or may be less robust than flanges for barrels without metal coating 104.

FIG. 3B is an expanded cross-section side view diagram illustrating the example barrel of FIG. 3A. Metal coating 104 may have a thickness 110 that is sufficiently high to resist impact damage and/or sufficiently low to resist thermally-induced cracking. Thickness 110 of metal coating 104 may be between about 5 micrometers and about 1500 micrometers, such as between about 5 micrometers and about 300 micrometers. Thickness 110 of metal coating 104 may be dependent on a method of formation of metal coating 104. For example, electrodeposition may carefully control a thickness of deposited metal to achieve a low thickness of metal coating 104.

Carbon fiber bands 106 may have a collective thickness that is sufficiently high to provide structural integrity to barrel 100, and an individual thickness 112 that is sufficiently high to prevent inadvertent puncture to polymer band 108. Thickness 112 of each carbon fiber band 106 may be between about 1.5 millimeters (e.g., 5 plies) to about 5 millimeters (e.g., about 15 plies). In some examples, a thickness of outermost carbon fiber band 106A may be higher than a thickness of outermost carbon fiber band 106B to provide enhanced mechanical, environmental, or thermal protection for polymer band 108. Polymer band 108 may have a thickness 114 that is sufficiently high to resist cutting. Thickness 114 of each polymer band 108 may be between about 2 millimeters (e.g., about 4 plies) to about 10 millimeters (e.g., about 30 plies). As a result, barrel 100 may be between about 5 millimeters to about 17 millimeters thick at a center portion. In examples in which more than two carbon fiber bands 106 and/or more than one polymer band 108 are used, thickness of each band 106 and/or 108 may collectively produce a desired function, and may provide additional functionality, such as tiered cut resistance between two polymer bands 108.

Thickness 116 of barrel 74 may be determined based on several variables such a value of mass of the fan blade 70 and a rotational speed and/or acceleration of the fan blade 70 of a particular gas turbine engine. An amount of momentum and force generated by a broken off fan blade may change depending on a type and the gas turbine engine. As such, for fan blades 70 that produce larger momentum or force, an overall thickness 116 of barrel 74 would be larger compared to circumstances where fan blades 70 produce smaller momentum or force.

FIG. 4 is a cross-section side view diagram illustrating an example barrel 120 of a fan containment case, such as barrel 74 of fan containment case 60. Barrel 120 includes a case structure 122 and a nanocrystalline metal coating 124. Case structure 122 includes a plurality of carbon fiber bands 126 including an outermost carbon fiber band 126A forming an outer surface of case structure 122, an innermost carbon fiber band 126B forming an inner surface of case structure 122, and an intermediate carbon fiber band 126C between outermost and innermost carbon fiber bands 126A and 126B. Case structure 122 also includes a first cut resistant polymer layer 128A between outermost carbon fiber band 126A and intermediate carbon fiber band 126C, and a second cut resistant polymer layer 128B between intermediate carbon fiber band 126C and innermost carbon fiber band 126B, such that second polymer layer 128B is radially inward of first polymer layer 128A. A length of first polymer layer 128A is greater than a length of second polymer layer 128B. Case structure 142 includes a forward portion 120A, a middle portion 120B, and an aft portion 120C. In the example of FIG. 4, first polymer layer 128A extends through only middle portion 120B, while second polymer layer 128B extends through the forward portion 120A, middle portion 120B, and aft portion 120C.

FIG. 5 is a cross-section side view diagram illustrating an example barrel 140 of a fan containment case, such as barrel 74 of fan containment case 60 of FIGS. 1 and 2.

Barrel 140 includes a case structure 142 and a nanocrystalline metal coating 144. Case structure 142 includes a plurality of carbon fiber bands 146 including an outermost carbon fiber band 146A forming an outer surface of case structure 142 and an innermost carbon fiber band 146B forming an inner surface of case structure 142, and a cut resistant polymer layer 148 (“polymer layer 148”) between outermost carbon fiber band 146A and innermost carbon fiber band 146B. Case structure 142 includes a forward portion 140A, a middle portion 140B, and an aft portion 140C. In the example of FIG. 5, an innermost surface of middle portion 140B is radially outward of an innermost surface of forward portion 140A and aft portion 140C to define an inner cavity 150. Inner cavity 150 is configured to at least partially contain a fan track liner, such as fan track liner 72 of fan containment case 60 of FIG. 2.

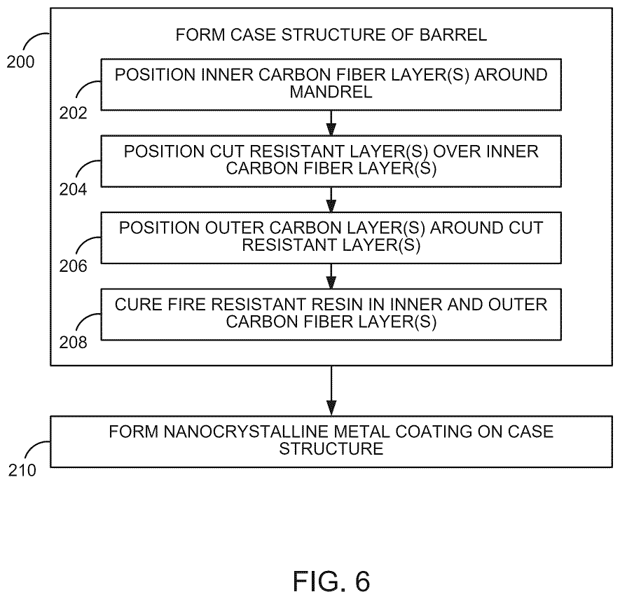

FIG. 6 is a flowchart of an example method for fabricating a barrel of a fan containment case, and will be described with respect to barrel 100 of FIG. 3. The method of FIG. 6 includes forming case structure 102 of barrel 100 (200). In some examples, such as illustrated in FIG. 6, case structure 102 may be formed through a lay-up process that includes laying up an innermost set of carbon fiber layers by positioning innermost carbon fiber layers around a mandrel and impregnating the carbon fiber layers with epoxy (202). The lay-up process further includes laying up at a set of cut resistant polymer layer by positioning cut resistant layers over the innermost set of carbon fiber layers (204). The lay-up process may include laying up at least one additional set of carbon fiber layers and at least one additional set of cut resistant polymer layers. The lay-up process further includes laying up an outermost set of carbon fiber layers by positioning the outermost set of carbon fiber layers over the set of cut resistant polymer layers and impregnating the carbon fibers with a fire resistant resin (206). After assembly of all carbon fiber and polymer layers, the method includes curing the fire resistant resin in the innermost set of carbon fiber layers to form innermost carbon fiber band 106B and the outermost set of carbon fiber layers to form outermost carbon fiber band 106A (208).

The method of FIG. 6 further includes forming nanocrystalline metal coating 104 overlying case structure 102. In some examples, forming nanocrystalline metal coating 104 includes electrodepositing a metal on at least a portion of the case structure. To form a nanocrystalline microstructure, various operating parameters of the electrodeposition, such as current density and bath temperature, may be carefully controlled. The metal may include a nickel-based alloy, chromium-based alloy, cobalt-based alloy, iron-based alloy, or nickel composite alloy. The metal may be deposited to a thickness between about 5 micrometers and about 300 micrometers. In addition or alternative to electrodeposition, other techniques to form metal coating 104 may include, but are not limited to, thermal spray techniques, such as plasma spraying; physical vapor deposition (PVD), chemical vapor deposition (CVD), cold spraying, laser cladding, and the like.

Example 1: A fan containment case includes a barrel includes a case structure includes a plurality of carbon fiber bands, wherein at least an outermost carbon fiber band and an innermost carbon fiber band include a fire resistant polymer matrix; and at least one cut resistant polymer band between the outermost and the innermost carbon fiber bands; and a nanocrystalline metal coating overlying the case structure.

Example 2: The fan containment case of example 1, wherein a ductility of the nanocrystalline metal coating is greater than about 1% elongation, and wherein a hardness of the nanocrystalline metal coating is greater than about 400 Vickers (HV).

Example 3: The fan containment case of any of examples 1 and 2, wherein a thickness of the nanocrystalline metal coating is between about 5 micrometers and about 300 micrometers.

Example 4: The fan containment case of any of examples 1 through 3, wherein the nanocrystalline metal coating comprises at least one of a nickel-based coating, a chromium-based coating, a cobalt-based coating, an iron-based coating, or a nickel composite coating.

Example 5: The fan containment case of any of examples 1 through 4, wherein the at least one cut resistant polymer layer has a total heat release less than about five kilojoules per gram (kJ/g).

Example 6: The fan containment case of any of examples 1 through 5, wherein the at least one cut resistant polymer band has a thermal degradation temperature greater than about 600 degrees Celsius (° C.) .

Example 7: The fan containment case of any of examples 1 through 6, wherein the at least one cut resistant polymer layer comprises poly p-phenylene-2,6-benzobisoxazole (PBO).

Example 8: The fan containment case of any of examples 1 through 7, wherein the case structure comprises a forward portion, a middle portion, and an aft portion, wherein the middle portion includes at least a portion of the at least one cut resistant polymer layer, and wherein a thickness of the middle portion is greater than a thickness of the forward and aft portions.

Example 9: The fan containment case of example 8, wherein the at least one cut resistant polymer layer comprises a first cut resistant band and a second cut resistant polymer band radially inward of the first cut resistant polymer band.

Example 10: The fan containment case of example 9, wherein a length of the second cut resistant polymer layer is greater than the length of the first cut resistant polymer layer.

Example 11: The fan containment case of example 10, wherein the first cut resistant polymer layer extends through only the middle portion, and wherein the second cut resistant polymer layer extends through the forward portion, the middle portion, and the aft portion.

Example 12: The fan containment case of any of examples 8 through 11, wherein an innermost surface of the middle portion is radially outward of an outermost surface of the forward and aft portions to define an inner cavity, and wherein the inner cavity is configured to at least partially contain a fan track liner.

Example 13: The fan containment case of any of examples 1 through 12, further comprising a fan track liner positioned on an inner surface of the barrel.

Example 14: A gas turbine engine includes a fan containment case includes a barrel includes a case structure includes a plurality of carbon fiber bands, wherein at least an outermost carbon fiber band and an innermost carbon fiber band include a fire resistant polymer matrix; and at least one cut resistant polymer band between the outermost and the innermost carbon fiber bands; and a nanocrystalline metal coating overlying the case structure.

Example 15: The gas turbine engine of example 14, wherein the gas turbine engine further comprises a fan comprising a plurality of fan blades, and wherein the fan containment case further comprises a fan track liner positioned on an inner surface of the barrel and configured to abrade in response to contact with a fan blade of the plurality of fan blades.

Example 16: A method of fabricating a fan containment case includes forming a nanocrystalline metal coating overlying a case structure, wherein the case structure comprises: a plurality of carbon fiber bands, wherein at least an outermost carbon fiber band and an innermost carbon fiber band include a fire resistant polymer matrix; and at least one cut resistant band between the outermost and the innermost carbon fiber bands.

Example 17: The method of example 16, wherein forming the nanocrystalline metal coating comprises electrodepositing a metal on at least a portion of the case structure.

Example 18: The method of any of examples 16 and 17, wherein a thickness of the nanocrystalline metal coating is between about 5 micrometers and about 300 micrometers.

Example 19: The method of any of examples 16 through 18, wherein the nanocrystalline metal coating comprises at least one of a nickel-based alloy, a chromium-based alloy, a cobalt-based alloy, an iron-based alloy, or a nickel composite alloy.

Example 20: The method of any of examples 16 through 19, further includes laying up an innermost set of carbon fiber layers, at least one set of cut resistant polymer layers overlying the innermost set of carbon fiber layers, and laying up an outermost set of carbon fiber layers overlying the at least one set of cut resistant polymer layers; and curing epoxy to form the innermost carbon fiber band from the innermost set of carbon fiber layers and the outermost carbon fiber band from the outermost set of carbon fiber layers.

Various examples have been described. These and other examples are within the scope of the following claims.

What is claimed is:

1. A containment case, comprising:
a barrel comprising:
a case structure comprising:
a plurality of carbon fiber bands, wherein at least an outermost carbon fiber band and an innermost carbon fiber band include a fire resistant polymer matrix; and
at least one cut resistant polymer band between the outermost and the innermost carbon fiber bands; and
a nanocrystalline metal coating overlying the case structure.

2. The containment case of claim 1,
wherein a ductility of the nanocrystalline metal coating is greater than about 1% elongation, and
wherein a hardness of the nanocrystalline metal coating is greater than about 400 Vickers (HV).

3. The containment case of claim 1, wherein a thickness of the nanocrystalline metal coating is between about 5 micrometers and about 300 micrometers.

4. The containment case of claim 1, wherein the nanocrystalline metal coating comprises at least one of a nickel-based coating, a chromium-based coating, a cobalt-based coating, an iron-based coating, or a nickel composite coating.

5. The containment case of claim 1, wherein the fire resistant polymer matrix has a total heat release less than about five kilojoules per gram (kJ/g).

6. The containment case of claim 1, wherein the at least one cut resistant polymer band has a thermal degradation temperature greater than about 600 degrees Celsius (° C.).

7. The containment case of claim 1, wherein the at least one cut resistant polymer layer comprises poly p-phenylene-2,6-benzobisoxazole (PBO).

8. The containment case of claim 1,
wherein the case structure comprises a forward portion, a middle portion, and an aft portion,
wherein the middle portion includes at least a portion of the at least one cut resistant polymer layer, and
wherein a thickness of the middle portion is greater than a thickness of the forward and aft portions.

9. The containment case of claim 8, wherein the at least one cut resistant polymer layer comprises a first cut resistant band and a second cut resistant polymer band radially inward of the first cut resistant polymer band.

10. The containment case of claim 9, wherein a length of the second cut resistant polymer layer is greater than the length of the first cut resistant polymer layer.

11. The containment case of claim 10,
wherein the first cut resistant polymer layer extends through only the middle portion, and
wherein the second cut resistant polymer layer extends through the forward portion, the middle portion, and the aft portion.

12. The containment case of claim 8,
wherein an innermost surface of the middle portion is radially outward of an outermost surface of the forward and aft portions to define an inner cavity, and
wherein the inner cavity is configured to at least partially contain a fan track liner.

13. The containment case of claim 1, further comprising a fan track liner positioned on an inner surface of the barrel.

14. A gas turbine engine, comprising:
a containment case comprising:
a barrel comprising:
a case structure comprising:
a plurality of carbon fiber bands, wherein at least an outermost carbon fiber band and an innermost carbon fiber band include a fire resistant polymer matrix; and
at least one cut resistant polymer band between the outermost and the innermost carbon fiber bands; and
a nanocrystalline metal coating overlying the case structure.

15. The gas turbine engine of claim 14,
wherein the gas turbine engine further comprises a fan comprising a plurality of fan blades, and
wherein the containment case further comprises a fan track liner positioned on an inner surface of the barrel and configured to abrade in response to contact with a fan blade of the plurality of fan blades.

16. A method of fabricating a containment case, comprising:
forming a nanocrystalline metal coating overlying a case structure, wherein the case structure comprises:
a plurality of carbon fiber bands, wherein at least an outermost carbon fiber band and an innermost carbon fiber band include a fire resistant polymer matrix including an outermost carbon fiber layer and an innermost carbon fiber band; and
at least one cut resistant band between the outermost and the innermost carbon fiber bands.

17. The method of claim 16, wherein forming the nanocrystalline metal coating comprises electrodepositing a metal on at least a portion of the case structure.

18. The method of claim 16, wherein a thickness of the nanocrystalline metal coating is between about 5 micrometers and about 300 micrometers.

19. The method of claim 16, wherein the nanocrystalline metal coating comprises at least one of a nickel-based alloy, a chromium-based alloy, a cobalt-based alloy, an iron-based alloy, or a nickel composite alloy.

20. The method of claim 16, further comprising forming the case structure by at least:
laying up an innermost set of carbon fiber layers, at least one set of cut resistant polymer layers overlying the innermost set of carbon fiber layers, and an outermost set of carbon fiber layers overlying the at least one set of cut resistant polymer layers with a fire resistant resin; and
curing the fire resistant resin to form the innermost carbon fiber band from the innermost set of carbon fiber layers and the outermost carbon fiber band from the outermost set of carbon fiber layers.
